(19) United States
(12) Patent Application Publication
(10) Pub. No.: US 2023/0227032 A1
(43) Pub. Date: Jul. 20, 2023

(54) Vehicle Dynamics Classification for Collision and Loss of Control Detection

(71) Applicant: Motional AD LLC, Boston, MA (US)

(72) Inventors: Ruben Strenzke, Singapore (SG); Marc Dominik Heim, Singapore (SG)

(21) Appl. No.: 18/095,040

(22) Filed: Jan. 10, 2023

Related U.S. Application Data
(60) Provisional application No. 63/301,172, filed on Jan. 20, 2022.

(51) Int. Cl. B60W 30/095; B60W 40/105

(52) U.S. Cl. CPC B60W 30/0953; B60W 40/105; B60W 2554/4049; B60W 2520/28

(57) ABSTRACT

Provided are methods, systems, and computer program products for vehicle dynamics classification for collision and loss of control detection. Some methods described also include obtaining sensor data associated with dynamics of a vehicle, wherein the dynamics characterize motion of the vehicle and the vehicle is associated with a dynamics event classification. The methods include obtaining predicted dynamics, wherein the predicted dynamics are based on control signals and feedback on control signals from a previous time instance. Additionally, the methods include determining the dynamics event classification of the vehicle based on the dynamics and the predicted dynamics and controlling operation of the vehicle according to the dynamics event classification.

### CROSS-REFERENCE TO RELATED APPLICATIONS

The present application claims priority to U.S. Provisional Patent Application No. 63/301,172, filed on Jan. 20, 2022, entitled “Vehicle Dynamics Classification for Collision and Loss of Control Detection,” which is herein incorporated by reference in its entirety.

### BACKGROUND

Vehicles are configured with systems or devices that detect collisions or loss of control using data associated with vehicle dynamics. The detection of collisions or a loss of control is essential for operation of an autonomous vehicle, which can operate without a human driver or operator. In some cases, the vehicle dynamics representative of nominal vehicle behavior are similar to the vehicle dynamics that indicate a collision or loss of control. Additionally, systems or devices that detect collisions or loss of control are do not provide information to recover from detected collisions or loss of control.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a diagram of an implementation of a process for vehicle dynamics classification;

FIG. 6A is a block diagram of a system that enables vehicle dynamics classification;

FIG. 6B is an illustration of a system that creates an environment feature vectors;

FIG. 7A is a block diagram of vehicle dynamics classification with a multi-layer neural network;

FIG. 7B is a block diagram of vehicle dynamics classification with a multi-layer recursive neural network or a long short term memory network; and

FIG. 8 is an illustration of a flowchart of a process for vehicle dynamics classification.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement vehicle dynamics classification for collision and loss of control detection. Dynamics events are identified, such as collision (COL), loss of control (LOC), or nominal events, during operation of a vehicle. Sensor data associated with the dynamics of a vehicle is captured, where the sensor data characterizes motion of the vehicle. Predicted dynamics of the vehicle are determined based on control signals and feedback on control signals from a previous time instance. A dynamics event classification of the vehicle is determined based on the dynamics and the predicted dynamics. In embodiments, the dynamics event classification is based on additional environmental information output by an environmental model.

By virtue of the implementation of systems, methods, and computer program products described herein, techniques for vehicle dynamics classification for collision and loss of control can provide a dynamics event classification and assistive information to enable an intelligent vehicle response to counteract the loss of control or collision. In examples, the intelligent vehicle response is based on sensor data associated with dynamics, wherein the sensor data is of a precision and accuracy that preempts a similar human response to a loss of control or collision event. Further, the present techniques improve the operation and safety of the vehicle by accurately detecting loss of control and collision events that share characteristics that reflect nominal vehicle behavior.

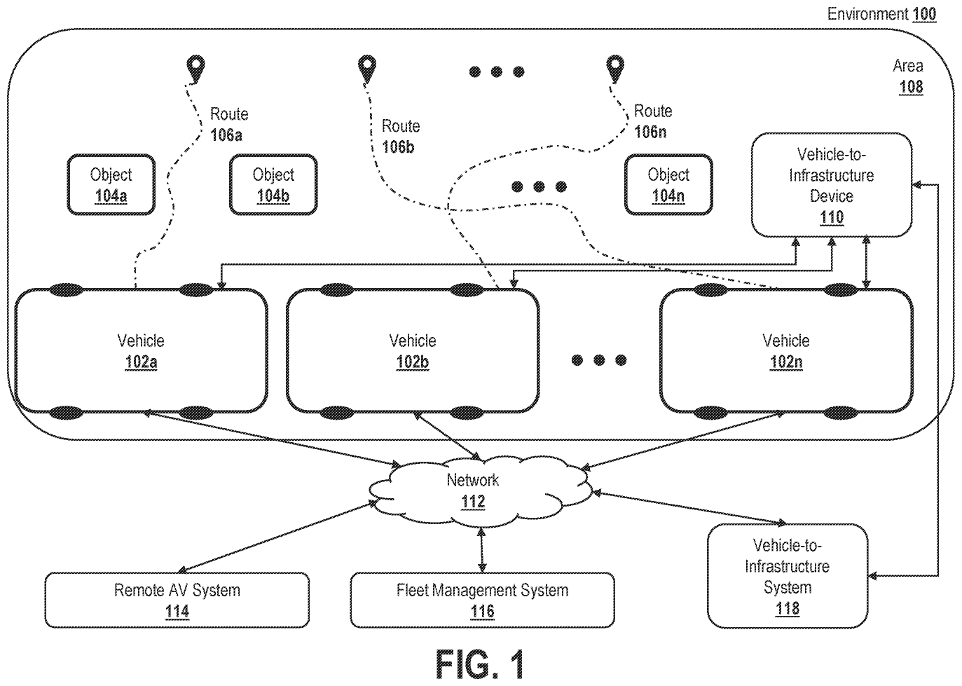

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

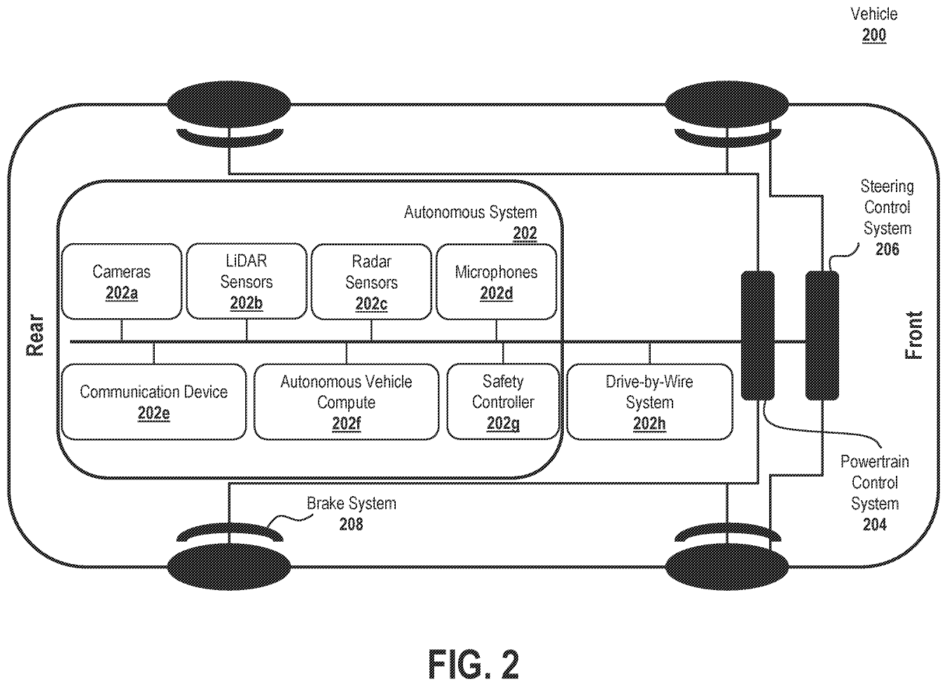

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

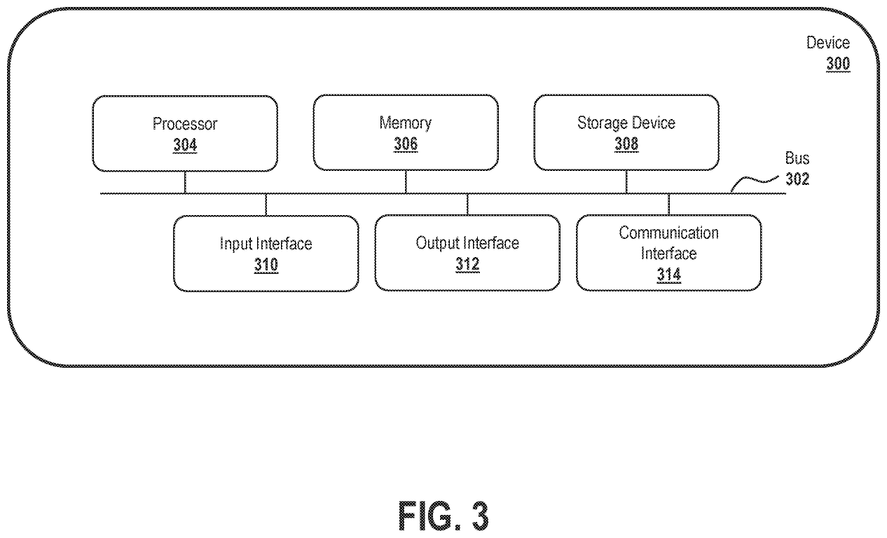

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

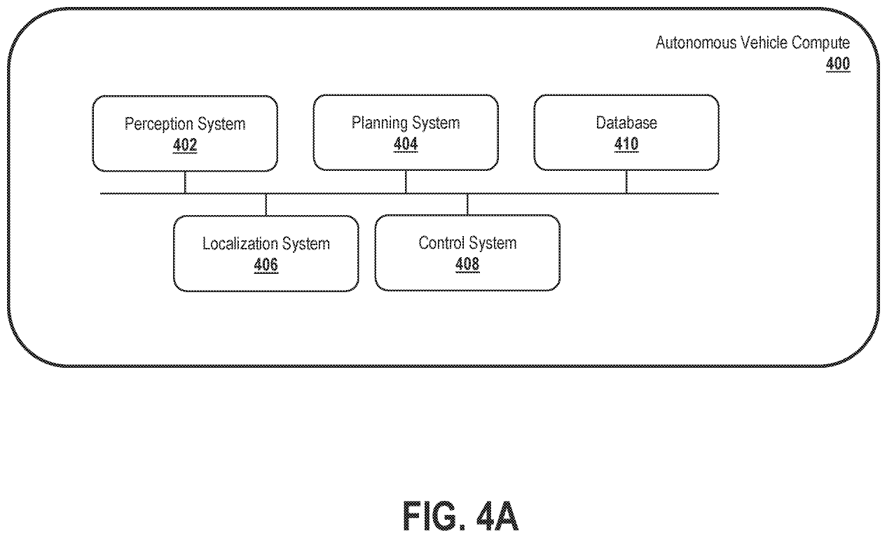

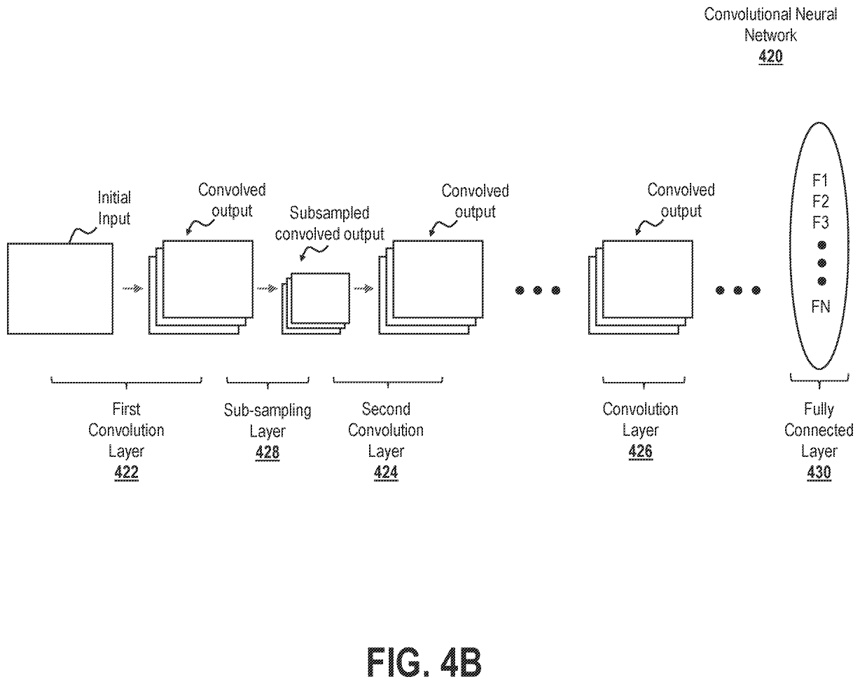

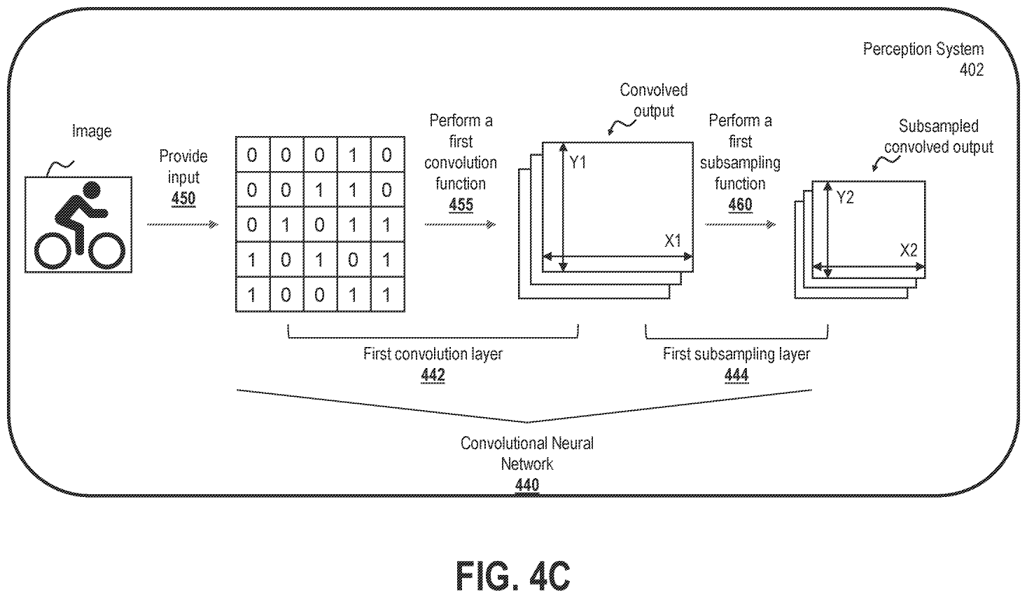

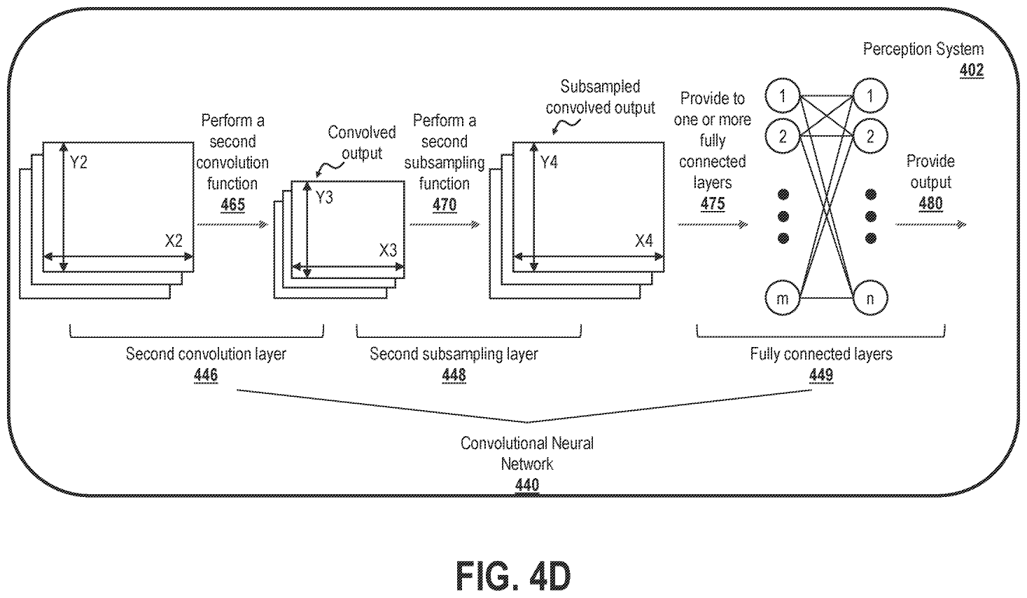

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

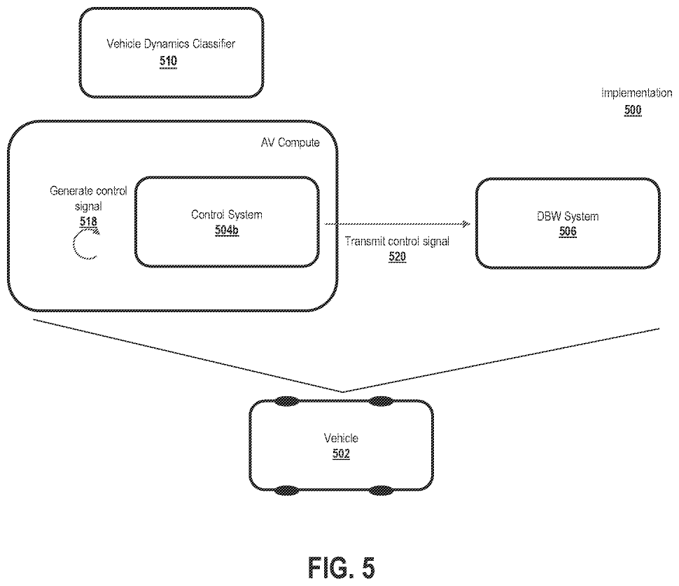

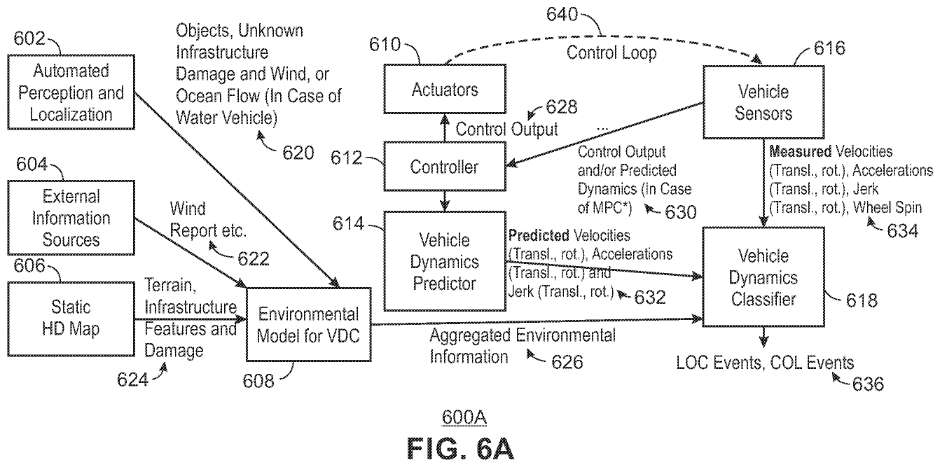

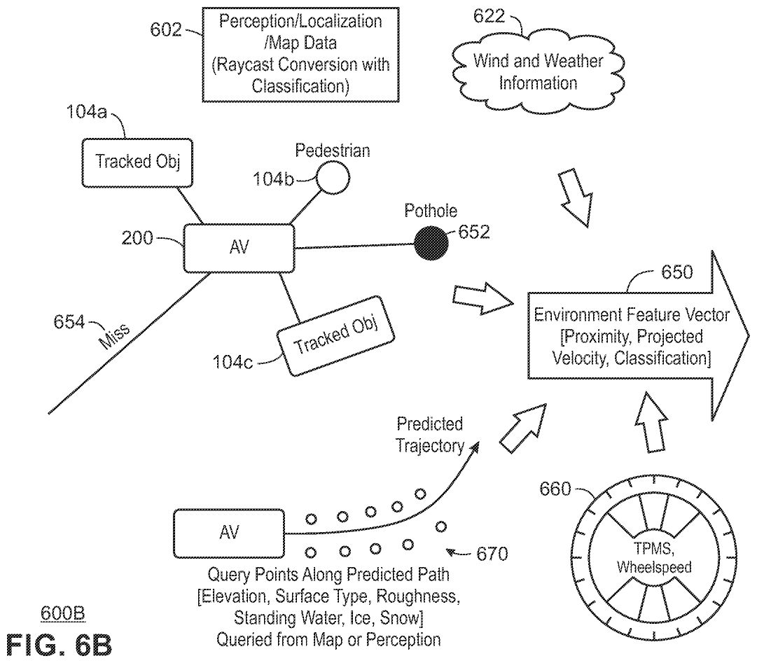

Referring now to FIG. 5, illustrated is a diagram of an implementation 500 of vehicle dynamics classification for collision and loss of control detection. In some embodiments, implementation 500 includes a vehicle dynamics classifier 510. In some embodiments, the vehicle dynamics classifier 510 is the same as or similar to the vehicle dynamics classifier 618 of FIG. 6A. In some embodiments, the vehicle dynamics classifier is implemented by one or more systems separate from the AV compute of vehicle 502. Additionally, or alternatively, the vehicle dynamics classifier can be implemented by one or more systems included in the AV compute of vehicle 502. In some embodiments, the AV compute of vehicle 500 is the same as, or similar to, the AV compute 400 illustrated in FIG. 4.

In the example of FIG. 5, a control system 504b of the AV compute generates a control signal at reference number 518. The control signal is transmitted to a DBW system 506 at reference number 520. In operation, the control signal 518 can cause the vehicle 502 to undergo planned maneuvers, where planned maneuvers include planned trajectories and associated dynamics. The planned maneuvers are representative of nominal vehicle behavior. In examples, the planned maneuvers share characteristics with dynamics events such as a collision or a loss of control dynamics. Generally, vehicle dynamics events can exhibit senor readings (e.g., sensor data) similar to sensor readings associated with nominal vehicle behavior. For example, collisions and loss of control can be associated with sensor data that is within predetermined ranges of sensor data associated with nominal vehicle behavior. However, the events themselves are not reflective of nominal vehicle behavior. Put another way, nominal vehicle behavior and collisions/loss of control events have an overlap when viewed in terms of associated dynamics.

In examples, nominal vehicle behavior refers to an intended motion of the vehicle (e.g., intended vehicle motion). Nominal vehicle behavior includes vehicle functionality when navigating as expected through an environment according to traffic laws and generally understood rules of the road. In examples, nominal vehicle behavior is determined based on one or more thresholds applied to vehicle functionality. Thus, nominal vehicle behavior can be referred to as control of the vehicle that is “within range.” In some cases, nominal vehicle behavior is expected vehicle behavior to reach a destination. A loss of control indicates a loss of one or more functions associated with vehicle operation, such as braking, steering, or throttle functionality. In examples, a loss of control results in vehicle motion that is contrary to expected vehicle behavior. A collision indicates the vehicle coming into contact with another object (e.g., objects 104a-104n) or vehicle, or vice versa.

As an example, consider a control signal that commands braking with excessive force and is transmitted to the DBW system 506 at reference number 520. Braking with excessive force is a response to objects entering the path of the vehicle or other conditions that cause an immediate and abrupt deceleration of the vehicle. In some embodiments, braking with excessive force includes the application of brakes that results in a deceleration force greater than braking under nominal conditions. The present techniques include a vehicle dynamics classifier 510 that determines if the AV is in a dynamics event based on the control signal. In the example of harsh braking, the present techniques determine the behavior of the AV, such as if the AV decelerates as expected or if the AV decelerates more or less than expected. In embodiments, the behavior of the AV in response to a control signal can indicate a loss of control or a collision as determined by a vehicle dynamics classifier. In embodiments, the dynamics event classification is also based on predicted vehicle dynamics. Predicted vehicle dynamics include, for example, braking, steering, throttle, or other data that characterizes motion of the vehicle. In embodiments, the predicted vehicle dynamics are input to the vehicle dynamics classifier to determine the events associated with the vehicle dynamics.

FIG. 6A is a block diagram of a system 600A that enables vehicle dynamics classification. In the example of FIG. 6A, a vehicle dynamics classifier 618 takes as input predicted dynamics 632 from a vehicle dynamics predictor 614 and sensor data 634 from vehicle sensors 616. The vehicle dynamics classifier 618 outputs a prediction of a current vehicle state 636 as an intended motion, loss of control, or collision. In embodiments, aggregated environmental information 626 is provided as input to the vehicle dynamics classifier 618. In embodiments, the aggregated environmental information 626 is an environment feature vector output by an environmental model 608 as described with respect to FIG. 6B. In some examples, the system 600A is implemented by one or more systems separate from the AV compute of vehicle 500. Additionally, or alternatively, the system 600A can be implemented by one or more systems included in the AV compute of vehicle 502. In some embodiments, the AV compute of vehicle 502 is the same as, or similar to, the AV compute 400 illustrated in FIG. 4. Additionally, or alternatively, the system 600A can be implemented by one or more systems included in the autonomous system 202 of FIG. 2.

Generally, a vehicle includes vehicle sensors 616 that capture data associated with the vehicle or the environment in which the vehicle operates. In examples, sensor data 634 output by the sensors 616 include measured translational and rotational velocities, accelerations, jerk, and wheel spin. Sensor data 634 is processed by an autonomous vehicle compute (e.g., autonomous vehicle compute 400) to calculate control output and/or predictive dynamics 630. The control output and/or predictive dynamics 630 are transmitted to a controller 612. The controller 612 transmits a control output 628 to actuators 610 and a vehicle dynamics predictor 614. In embodiments, the actuators 610 include braking, steering, and throttle devices. The actuators 610 produce motion of the vehicle by converting control output 628 from the controller 612 to rotary or linear motion as indicated by the control output 628. The motion of the vehicle as achieved by the actuators 610 is detected by the vehicle sensors 616 as illustrated by the dashed line, forming a control loop 640. Put another way, captured data from the vehicle sensors 616 is processed to provide control output or predictive dynamics to a controller 612. In turn, the controller 612 generates control output 628 (e.g., control signals) that are transmitted to actuators 610 and a vehicle dynamics predictor 614. The actuators 610 cause movement of the vehicle in accordance with the control output 628, which is in turn detected by the vehicle sensors 616 to form a control loop for vehicle dynamics. In embodiments, the control loop 640 includes physical components and control functions executed to adjust the output of the actuators to desired values based on the sensor data 616.

As illustrated in the example of FIG. 6A the vehicle dynamics predictor 614 is a separate system from the controller 612. In the example of FIG. 6A, control output 628 is provided as input to the vehicle dynamics predictor 614, and the vehicle dynamics predictor 614 outputs predicted dynamics 632. The predicted dynamics 632 include predicted velocities, accelerations, and jerk. In an embodiment, the vehicle dynamics predictor 614 is collocated with the controller 612. In embodiments, the controller 612 is a model predictive controller (MPC). Generally, an MPC combines the calculations of control signals with feedback on control signals from a previous prediction horizon to predict future control output. Accordingly, future control output values are predicted using a model and current measurements (e.g., sensor data). The control signals are calculated to minimize an objective function while satisfying one or more constraints.

The vehicle dynamics predictor 614 predicts future velocities, accelerations, and jerk based on control output 628 and control signals from a previous time instance. In examples, the controller 612 is an MPC and includes a model of velocity, accelerations, and jerk. In this case, the MPC calculates predictive dynamics (e.g., predictive velocities, accelerations, and jerk) and outputs the predictive dynamics for input to the vehicle dynamics classifier. When the controller 612 does not include model predictive dynamics, the vehicle dynamics predictor 614 monitors past dynamics to predict dynamics of the vehicle. Accordingly, while the example provided in FIG. 6A includes a vehicle dynamics predictor 614 that is separate from the controller 612, in embodiments the functionality of the vehicle dynamics predictor 614 and controller 612 is realized using a model predictive controller.

As an example, consider a scenario where the motion of the vehicle as output by the actuator 610 is not equivalent to the realized motion of the vehicle in the real-world or environment. For example, during adverse weather conditions, the control output 628 can command a vehicle speed of approximately 35 mph. The actuators 610 implement braking, steering, and/or throttle functions based on the control output 628 to achieve a speed of approximately 35 mph in response to the command. In this example, adverse weather conditions cause the actual vehicle speed in the real-world/environment to be less than or greater than the 35 mph commanded by the control output 628 and output by the actuators 610. In such an example, an MPC or the vehicle dynamics predictor can predict future dynamics based on the commanded control output and measured data (e.g., sensor data). The predicted dynamics 632 are provided as input into the vehicle dynamics classifier 618. The vehicle dynamics classifier (VDC) 618 classifies the obtained inputs into an event, such as intended motion, collision, or a loss of control. In embodiments, the vehicle dynamics classifier 618 includes a behavioral classifier that outputs a behavior to recover from the event predicted by the vehicle dynamics classifier. For example, the behavior to recover from the event is modified acceleration, deceleration, velocity, steering angle, and the like.

In embodiments, additional aggregated environmental information 626 is provided as input to the vehicle dynamics classifier 618. The aggregated environmental information 626 is additional environmental information relevant to classifying the event and reacting to the event. In examples, the aggregated environmental information enables a determination of a location associated with the event or issues associated with a loss of control event. In examples, map data 606 or external information sources 604 (e.g., vehicle to vehicle information) are used when reporting the event. In the example of FIG. 6A, automated perception and localization 602 provides detected objects (e.g., objects 104) for input into the environmental model 608. Additionally, external information sources 604 provide external information 622 for input into the environmental model 608. Further, a static high definition (HD) map 606 provides map data 624 as input to the environmental model 608. In embodiments, the map data 624 includes terrain, infrastructure features, and damage. The environmental model 608 takes as input the detected objects 620, external information 622, and map data 624 and outputs aggregated environmental information 626. In examples, the aggregated environmental information 626 is an environment feature vector as described with respect to FIG. 6B. Accordingly, in embodiments, the vehicle dynamics classifier 618 takes as input sensor data 634, predicted dynamics 632, and additional aggregated environmental information 626, and outputs a dynamics event classification 636.

FIG. 6B is an illustration of a system 600B that creates an environment feature vectors 650. In examples, the environment feature vectors 650 correspond to detected objects in an environment (e.g., environment 100 of FIG. 1). In embodiments, the environment feature vectors 650 include, for each detected object, a proximity of the detected object to the vehicle, a projected velocity of the detected object, a classification of the detected object, or any combinations thereof.

As discussed with respect to FIG. 6A, the external data 622 includes wind and weather information. The external data is used to determine the environment feature vectors 650. Additionally, in the example of FIG. 6B, perception and localization data 602 is provided to determine the environment feature vector 650. In examples, the perception localization data 602 includes raycast conversion with classification. In the example of FIG. 6B, data from automated perception and localization 602 typically used for navigation is re-purposed to predict the vehicle dynamics classification. Additionally, in the example of FIG. 6B, road conditions 670 and wheel speed 660 are provided to determine environment feature vectors 650. In embodiments, road conditions 670 are observed according to sample points taken along a predicted trajectory planned by the vehicle (e.g., planning system 402). In particular, the data associated with points along the predicted trajectory includes an elevation, surface type, roughness, standing water, ice, snow, and the like. In embodiments, this information is extracted at predetermined points along the predicted trajectory using automated perception and localization 602.

In addition to external information 622, automated perception and localization 602, wheel speed 660, and road conditions 670 object data associated with detected objects in the environment is provided to determine the environment feature vectors 650. In particular, tracked objects 104a, 104b, and 104c, are provided, along with their distance to the AV. Moreover, detected hazardous objects such as a pothole 652 are identified to calculate an environment feature vector 650. In some cases, data associated with an area behind the vehicle indicating missed objects 654 is provided for inclusion in an environment feature vector.

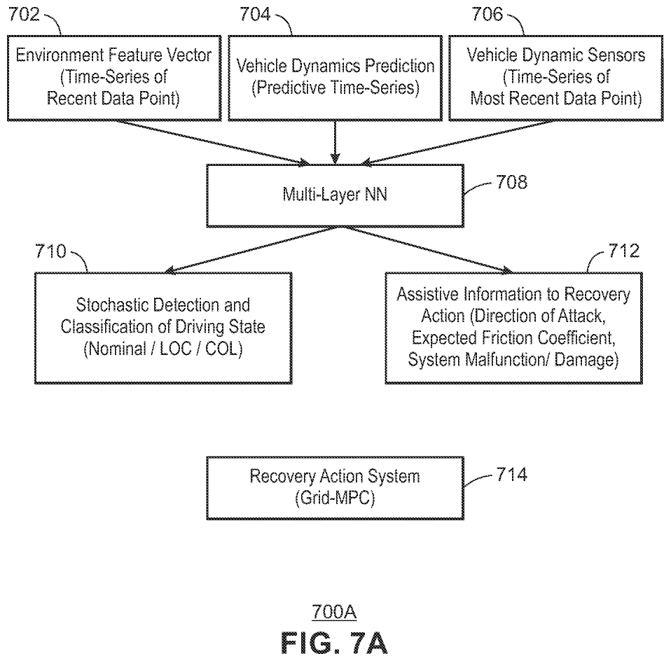

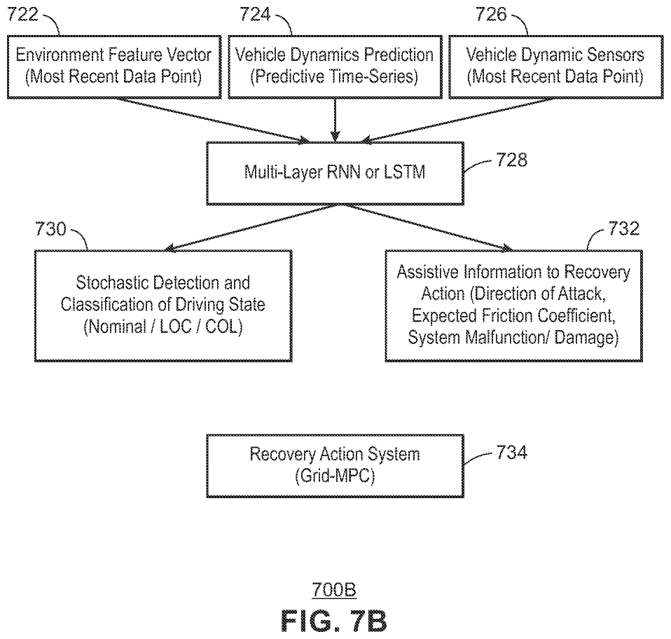

FIG. 7A is a block diagram of vehicle dynamics classification using a multi-layer neural network 708. In the example of FIG. 7A, an environment feature vector 702, vehicle dynamics prediction 704, and vehicle dynamics sensor data 706 are provided as input to a multi-layer neural network 708. The inputs to the multi-layer neural network 708 are time-series data. In particular, the environment feature data 702 is a time-series of a recent data point. The vehicle dynamics prediction 704 is a predictive time-series. Additionally, the vehicle dynamics sensor data is a time series of a recent data point.

The multi-layer neural network 708 outputs a stochastic detection and classification 710 of a driving state of the vehicle. In embodiments, the driving state of the vehicle is one of a nominal, loss of control, or collision event. Additionally, the multi-layer neural network outputs assistive information to determine a recovery action using a recovery action system 714. Generally, a recovery action is a behavior that is implemented by the vehicle to counter or mitigate a collision or loss of control event. In examples, a recovery action is a direction of attack, expected friction coefficient, an indication of system malfunction/damage, or any combinations thereof. A recovery action system 714 (Grid-MPC) is used to implement recovery actions in view of the dynamics event classification. In embodiments, the recovery action system includes a model predictive controller, such as controller 612 of FIG. 6A. The recovery actions are intelligent responses that counteract the loss of control or collision. In examples, an intelligent response is based on historical vehicle dynamics and predictive vehicle dynamics.

FIG. 7B is a block diagram of vehicle dynamics classification with a multi-layer recursive neural network or a long short term memory network 708. In the example of FIG. 7B, an environment feature vector 722, vehicle dynamics prediction 724, and vehicle dynamics sensor data 726 are provided as input to a multi-layer RNN or LTSM 728. The inputs to the multi-layer RNN or LTSM 728 are a most recent data point and predictive time series data. In particular, the environment feature data 722 is a most recent data point. The vehicle dynamics prediction 724 is a predictive time-series. Additionally, the vehicle dynamics sensor data is a most recent data point.

In embodiments, FIG. 7B illustrates a generic network operable using an RNN or LTSM. In embodiments, the RNN or LTSM 728 takes as input the most recent data points as captured by the environment feature vector 722 or the vehicle dynamic sensors 726, and the network processed the data internally over multiple frames or cycles. Similar to FIG. 7A, the multi-layer RNN or LTSM 728 outputs a stochastic detection and classification 730 of a driving state of the vehicle. The multi-layer neural network also outputs assistive information to determine a recovery action 732, and a recovery action system 734 (Grid-MPC) is used to implement recovery actions in view of the dynamics event classification.

Generally, FIGS. 7A and 7B each output a classification of a dynamics event of a vehicle. In embodiments, the multi-layer neural network 708 or the multi-layer RNN or LTSM 728 outputs assistive information 712, 732, respectively. In embodiments, the assistive information 712, 732 is output by a behavioral classifier. The assistive information 712, 732 can indicate a type of loss of control or a type of collision. In embodiments, the multi-layer neural network 708 or the multi-layer RNN or LTSM 728 are trained using driving data associated with human operation of a vehicle. In embodiments, the present techniques improve a receiver operating characteristic (ROC) curve associated with the multi-layer neural network 708 or the multi-layer RNN or LTSM 728. Generally, the ROC curve illustrates a diagnostic ability of the multi-layer neural network 708 or the multi-layer RNN or LTSM 728.

In embodiments, the vehicle dynamics classification is used in conjunction with other event detection techniques. As an example, a distributed sensor network with dedicated local sensors (e.g., a dedicated distributed sensor network) can be used to detect dynamics events. In this example, the sensors capture data associated with vehicle dynamics that are used to classify the event into nominal vehicle behavior, loss of control, or collision. Data from the distributed sensor network is provided as input to the vehicle dynamics classifier. In another example, electronic stability control (ESC) data from an electronic stability control system is provided as input to the vehicle dynamics classifier. Generally, ESC is a low level system that operates based on data associated with wheels of the vehicle (e.g., wheel spin). An ESC system is used to determine that a certain wheel is slipping and can cause specific braking power to be applied to specific wheels. The present techniques are implemented with ESC to stabilize the vehicle and provide intelligent reasoning to counteract loss or control events or collisions.

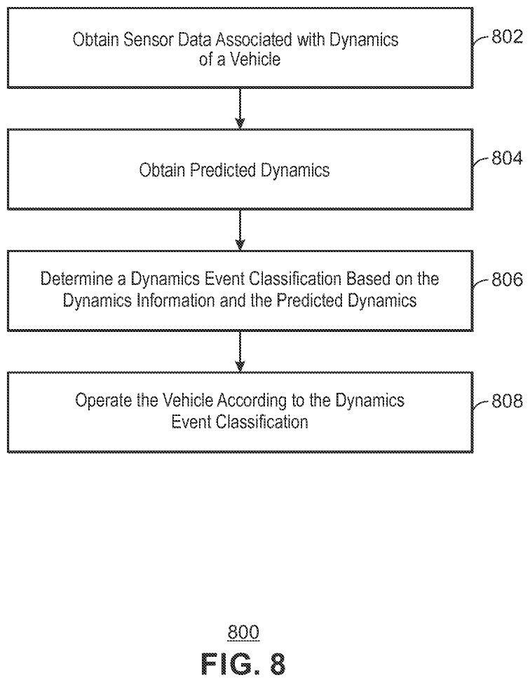

Referring now to FIG. 8, illustrated is a flowchart of a process 800 for vehicle dynamics classification for collision and loss of control. In some embodiments, one or more of the steps described with respect to process 800 are performed (e.g., completely, partially, and/or the like) by autonomous vehicle compute 400. Additionally, or alternatively, in some embodiments one or more steps described with respect to process 800 are performed (e.g., completely, partially, and/or the like) by another device or group of devices separate from or including device 300 of FIG. 3.

At block 802, sensor data associated with dynamics of a vehicle is received. In embodiments, the dynamics characterize motion of the vehicle, and the vehicle is associated with a dynamics event classification. A dynamics event classification, for example, is nominal, intended motion, loss of control, or collision. In examples, the dynamics event classification enables distinctions in sensor data associated with dynamics according to at least one time interval. For example, sensor data at a first time interval is classified as intended motion, and sensor data at a second time interval is classified as loss of control.

At block 804, predicted dynamics are received. Predicted dynamics are based on control signals and feedback on control signals from a previous time instance. In embodiments, predicted dynamics include velocity, acceleration, or jerk. In embodiments, the predicted dynamics are obtained from an MPC controller. At block 806, the dynamics event classification of the vehicle is determined based on the dynamics and the predicted dynamics. At block 808, the vehicle is operated according to the dynamics event classification.

The dynamics event classification according to the present techniques enables safer vehicle travel. For example, a vehicle that identifies a collision or loss of control in contrast to intended motion is able to provide information to the control system or user responsive to the classified event in the safest way possible. In examples where a road hazard is detected as indicated by the environment feature vector, the dynamics event classification provides information used by the vehicle to avoid sudden vehicle trajectory changes. Additionally, the control system and/or communications device of the vehicle can transmit the predicted dynamics event to nearby vehicles or networked locations based on responsive to the dynamics event classification. In this way, passengers, other vehicles, pedestrians, and animals within the environment are safer around the vehicle.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
obtaining, using at least one processor, sensor data associated with dynamics of a vehicle;
obtaining, using the at least one processor, predicted dynamics, wherein the predicted dynamics are based on control signals and feedback on control signals from a previous time instance;
determining, using the at least one processor, a dynamics event classification of the vehicle based on the dynamics and the predicted dynamics; and
controlling, using the at least one processor, operation of the vehicle according to the dynamics event classification.

2. The method of claim 1, comprising determining the dynamics event classification of the vehicle based on the dynamics, the predicted dynamics, and an environment feature vector.

3. The method of claim 2, wherein the environment feature vector is generated for at least one detected object, and comprises a proximity of the at least one detected object, a projected velocity of the at least one detected object, and a classification of the at least one detected object.

4. The method of claim 1, wherein the predicted dynamics are output by a model predictive controller that captures intended vehicle motion and predicts dynamics of the vehicle.

5. The method of claim 1, comprising providing assistive information to generate an intelligent response to the dynamics event classification, wherein the assistive information comprises one or more recovery actions based on sensor data.

6. The method of claim 1, comprising providing assistive information as feedback for predicting vehicle dynamics, wherein the feedback is used to generate the predicted dynamics.

7. The method of claim 1, comprising determining the dynamics event classification of the vehicle based on dynamics, predicted dynamics, and sensor data from a dedicated distributed sensor network for collision or loss of control detection.

8. The method of claim 1, comprising determining the dynamics event classification of the vehicle based on dynamics, predicted dynamics, and an electronic stability control system, wherein the electronic stability control system provides wheel spin data as input to determine the dynamics event classification.

9. A system, comprising:
at least one sensor;
at least one processor, and
at least one non-transitory storage media storing instructions that, when executed by the at least one processor, cause the at least one processor to:
obtain sensor data associated with dynamics of a vehicle;
obtain predicted dynamics that are based on control signals and feedback on control signals from a previous time instance;
determine a dynamics event classification of the vehicle based on the dynamics and the predicted dynamics; and
control operation of the vehicle according to the dynamics event classification.

10. The system of claim 9, comprising instructions that cause the at least one processor to determine the dynamics event classification of the vehicle based on the dynamics, the predicted dynamics, and an environment feature vector.

11. The system of claim 10, wherein the environment feature vector is generated for at least one detected object, and comprises a proximity of the at least one detected object, a projected velocity of the at least one detected object, and a classification of the at least one detected object.

12. The system of claim 9, wherein the predicted dynamics are output by a model predictive controller that captures intended vehicle motion and predicts dynamics of the vehicle.

13. The system of claim 9, comprising instructions that cause the at least one processor to provide assistive information to generate an intelligent response to the dynamics event classification, wherein the assistive information comprises one or more recovery actions based on sensor data.

14. The system of claim 9, comprising instructions that cause the at least one processor to provide assistive information as feedback for predicting vehicle dynamics, wherein the feedback is used to generate the predicted dynamics.

15. The system of claim 9, comprising instructions that cause the at least one processor to determine the dynamics event classification of the vehicle based on dynamics, predicted dynamics, and sensor data from a dedicated distributed sensor network for collision or loss of control detection.

16. The system of claim 9, comprising instructions that cause the at least one processor to determine the dynamics event classification of the vehicle based on dynamics, predicted dynamics, and an electronic stability control system, wherein the electronic stability control system provides wheel spin data as input to determine the dynamics event classification.

17. At least one non-transitory storage media storing instructions that, when executed by at least one processor, cause the at least one processor to:
obtain sensor data associated with dynamics of a vehicle;
obtain predicted dynamics that are based on control signals and feedback on control signals from a previous time instance;
determine a dynamics event classification of the vehicle based on the dynamics and the predicted dynamics; and
control operation of the vehicle according to the dynamics event classification.

18. The at least one non-transitory storage media of claim 17, comprising instructions that cause the at least one processor to determine the dynamics event classification of the vehicle based on the dynamics, the predicted dynamics, and an environment feature vector.

19. The at least one non-transitory storage media of claim 18, wherein the environment feature vector is generated for at least one detected object, and comprises a proximity of the at least one detected object, a projected velocity of the at least one detected object, and a classification of the at least one detected object.

20. The at least one non-transitory storage media of claim 17, wherein the predicted dynamics are output by a model predictive controller that captures intended vehicle motion and predicts dynamics of the vehicle.
